(19) United States
(12) Patent Application Publication
(10) Pub. No.: US 2008/0250967 A1
(43) Pub. Date: Oct. 16, 2008

(54) DYE DISCHARGING INK FOR INKJET PRINTING

(75) Inventors: Seiichi SOUMA, Tomi-city (JP); Satoshi Tsubamoto, Tomi-city (JP); Isao Tabayashi, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/099,400

(22) Filed: Apr. 8, 2008

(30) Foreign Application Priority Data
Apr. 9, 2007 (JP) 2007-101674

(51) Int. Cl. C09D 11/02

(52) U.S. Cl. 106/14.45; 106/31.13; 106/14.05

(57) ABSTRACT

A dye discharging ink for inkjet printing including at least a reducing agent and an amine compound. Embodiments of the dye discharging ink include, as the reducing agent, a sulphur reducing agent such as Rongalite, and, as the amine compound, an alcohol amine compound such as triethanolamine. Embodiments of the dye discharging ink also include a surface active surfactant and/or an antirust agent, and a pH in a range from 9.5 to 11.0. The dye discharging ink for inkjet printing can prevent corrosion of head nozzles due to acidic substances produced by decomposition of a reducing agent, so as to decrease inhibition of linear advancing property of ejected ink, and can prevent decrease in discharging capability due to hydrolysis of the reducing agent.

### CROSS-REFERENCE TO RELATED APPLICATION

The present application claims priority to Japanese Application No. 2007-101674, filed on Apr. 9, 2007, the entire contents of which are herein incorporated by reference.

### BACKGROUND OF THE INVENTION

1. Field of the Invention

The present invention relates to a discharging ink for inkjet printing.

2. Discussion of the Background

A dye discharging ink for inkjet printing that employs a reducing agent, such a sulphur reducing agent, is known (see, e.g., JP-A-63-21990). Dye discharging inks for inkjet printing that employ a sulphur reducing agent are excellent for decolorization of azo dyes. However, such dye discharging inks that use a sulphur reducing agent have a problem that acidic substances such as sulfate ion and/or carboxylic acid are produced due to changes over time, such as decomposition, oxidization, and volatilization, thus damaging an outer layer and an intermediate layer of an inkjet head.

In addition, a chelator and/or a surface active surfactant are added together with the reducing agent (see, e.g., JP-A-2004-143621) to prevent unevenness in decolorization. However, in the case of inkjet printing, the chelator or the surface active surfactant damages the outer layer of the head. As a result, positions of the outer layer around nozzles and a nozzle plate are damaged under continuous use, thus resulting in interference with the linear advancing property of ejected ink. In the case of an apparatus with a wiping function for wiping away dew drips that are produced due to volatile components of solvent on the surface of the nozzle plate, the damage to the nozzle plate worsens due to additional applying of physical damage by the wiping function.

Dye discharging inks for inkjet printing that use a sulphur reducing agent have a further problem that the dye discharging capability is reduced because the decomposition of the reducing agent progresses due to hydrolysis when stored over a long period of time.

### SUMMARY OF THE INVENTION

The present invention advantageously provides a dye discharging ink for inkjet printing including at least a reducing agent and an amine compound.

The present invention also advantageously provides a dye discharging ink for inkjet printing, where the dye discharging ink includes a discharging liquid, a reducing agent provided within the discharge liquid, and an amine compound provided within the discharge liquid in coexistence with the reducing agent.

Embodiments of the dye discharging ink of the invention can include, as the reducing agent, a sulphur reducing agent such as Rongalite, and, as the amine compound, an alcohol amine compound such as triethanolamine.

Embodiments of the dye discharging ink of the invention can also include a surface active surfactant, such as acetylene derivative, nonionic surfactant, and/or an antirust agent.

Embodiments of the dye discharging ink of the invention can also have a pH in a range from 9.5 to 11.0.

Embodiments of the present invention advantageously provide a dye discharging ink for inkjet printing that can prevent corrosion of head nozzles due to acidic substances produced by decomposition of a reducing agent, so as to decrease inhibition of linear advancing property of ejected ink, and can prevent decrease in discharging capability due to hydrolysis of the reducing agent.

### DETAILED DESCRIPTION OF EMBODIMENTS OF THE INVENTION

Embodiments of the present invention will be described hereinafter. In the following description, repetitive descriptions of features and elements of the embodiments will be made only when necessary.

Embodiments of the present invention advantageously provide a dye discharging ink for inkjet printing that prevents damage of an inkjet head due to a sulphur reducing agent and/or another factor, thereby enabling stable ejection of the discharging ink even when continuously used over a long period of time and maintaining its discharging capability over a long period of time.

Embodiments of the present invention advantageously provide a dye discharging ink for inkjet printing that is capable of inhibiting corrosion of material for head nozzles of an inkjet printer due to acidic substances produced by decomposition of a reducing agent, such as a sulphur reducing agent, thereby reducing inhibition of a linear advancing property of ejected ink. In addition, embodiments of the present invention advantageously provide a dye discharging ink for inkjet printing capable of decreasing damage of an ejection surface of an inkjet head caused by physical damage from a wiping mechanism on the ejection surface of the inkjet head (surface of a nozzle plate), thereby decreasing inhibition of linear advancing property of ejected ink. Furthermore, embodiments of the present invention advantageously provide a dye discharging ink for inkjet printing capable of preventing a decrease in dye discharging capability due to decomposition of a reducing agent caused by hydrolysis of the reducing agent, especially a sulphur reducing agent.

An exemplary embodiment of the present invention includes a dye discharging ink for inkjet printing that is characterized in that at least a reducing agent and an amine compound are contained to coexist in a discharging liquid.

The coexistence of the reducing agent and the amine compound in the discharging liquid provides a characteristic property that enables prevention of corrosion of material for head nozzles due to acidic substances produced by decomposition of the reducing agent, especially a sulphur reducing agent, and enables decrease in damage of an ejection surface of an inkjet head caused by physical damage from a wiping mechanism on the surface of the inkjet head. The prevention of corrosion of material of the head nozzles and decrease in damage of the ejection surface can decrease an inhibition of a linear advancing property of ejected dye discharging ink. The coexistence of the reducing agent and the amine compound in the discharging liquid also provides a characteristic property that enables prevention of a decrease in the discharging capability due to the decomposition of the reducing agent caused by hydrolysis of the reducing agent, especially the sulphur reducing agent. The reducing agent and the amine compound are preferably contained to coexist in the discharging liquid in such quantities as to exhibit at least one of the aforementioned characteristic properties, and are, more preferably, contained to coexist in the discharging liquid in such quantities as to exhibit both of the aforementioned characteristic properties.

Examples of the reducing agent used in embodiments of the invention include sulphur reducing agents such as sodium dithionite [hydrosulfite (Na₂S₂O₄)], Rongalite (e.g., Rongalit® C (NaHSO₂.CH₂O.H₂O), Rongalit® Z (ZnSO₂.CH₂O.H₂O), Decroline® (Zn(HSO₂.CH₂O)₂), etc.), sulfinic acids (e.g., thiourea dioxide, sodium hydrogen sulfite, and sodium thiosulfate), non-sulphur reducing agents having bleaching effect under acidic environment (e.g., stannous chloride (SnCl₂.2H₂O) and sodium chlorite), and non-sulphur reducing agents that are unstable when it is alone or in aqueous solution.

Embodiments of the present invention are particularly beneficial for dye discharging ink for inkjet printing that use a sulphur reducing agent, since the problems mentioned in background discussion are particularly serious when using a sulphur reducing agent. For example, embodiments of the present invention are particularly beneficial when Rongalite is used as the sulphur reducing agent, because even a small amount of Rongalite can exhibit high discharging effect.

The addition of the amine compound (especially, alcoholic amines) to the sulphur reducing agent according to embodiments of the invention leads to the following beneficial effects: (1) an effect of neutralizing acidic substances (sulfinic acid.carboxylic acid) produced by hydrolysis and/or oxidization of the sulphur reducing agent; (2) an effect of maintaining the pH alkali so as to prevent the deterioration of the reducing agent due to the hydrolysis of the sulphur reducing agent during long term storage (note that the hydrolysis of the sulphur reducing agent advances at an accelerating pace when the pH is lowered); and (3) an effect of protecting the head material, because the amine compound is coordinated on the head material, especially metallic compositions.

According to embodiments of the dye discharging ink for inkjet printing of the present invention, the amine compound and the sulphur reducing agent are preferably mixed to such an extent as to substantially exhibit the aforementioned effects (1) through (3) and, more preferably, to such an extent as to effectively exhibit the aforementioned effects (1) through (3).

Examples of the amine compound used in embodiments of the invention include aliphatic amines such as isopropylamine, n-hexylamine, didecylamine, dioctylamine, and tri-n-octylamine, aromatic amines, and alcohol amines such as triethanolamine.

According to embodiments of the invention, it is preferable to use an alcohol amine as the amine, because the alcohol amine can greatly exhibit the aforementioned effects (1) through (3), and because the alcohol amine has no metallic ion like NaOH, thus resulting in less color bleeding, which can be caused due to recombination between such a metallic ion and the dye that is decomposed during discharge printing.

According to embodiments of the invention, it is preferable to use triethanolamine as the alcohol amine, because triethanolamine can further greatly exhibit the aforementioned effects (1) through (3), and because triethanolamine has no metallic ion like NaOH, thus resulting in less color bleeding, which can be caused due to recombination between such a metallic ion and the dye that is decomposed during discharge printing.

In embodiments of the dye discharging ink for inkjet printing of the present invention, water only or preferably a mixture of water and an organic solvent can be used as the medium of the discharging liquid. Examples of the organic solvent include ethylene glycol systems (e.g., diethylene glycol) and pyrrolidones (e.g., N-methyl pyrrolidone).

In embodiments of the dye discharging ink for inkjet printing of the present invention, other components to be added can be a surface active surfactant (e.g., acetylene derivative/nonionic surfactant) and/or an antirust agent.

Embodiments of the dye discharging ink for inkjet printing of the invention preferably contain three components, which are preferably a reducing agent, an amine compound, and a surface active surfactant, and which are more preferably a sulphur reducing agent (e.g., Rongalite), an alcohol amine (e.g., triethanolamine), and a surface active surfactant (e.g., Surfynol®).

Embodiments of the dye discharging ink for inkjet printing of the present invention can include a discharging liquid for inkjet printing containing no colorants such as dye or pigment. The discharging liquid for inkjet printing can be used as a “discharging liquid containing a discharging agent” of a two-component type comprising the discharging liquid containing a discharging agent and an ink containing dye or pigment which are ejected from separate nozzles to print. There are the following forms: (A) discharging liquid containing a discharging agent+non-dye ink (pigment ink) [two-component type]; and (B) discharging liquid containing a discharging agent+dye ink (reducing-retardant dye) [two-component type].

Embodiments of the dye discharging ink for inkjet printing of the present invention can include a discharging liquid for inkjet printing of a one-component type, which contains colorants such as dye or pigment and is used as an ink to be ejected from a nozzle. The one-component type is used for so-called colored discharge printing in which coloring is conducted at the same time as discharge printing. There are the following forms: (C) discharging agent+non-dye ink (pigment ink) [one-component type]; and (D) discharging agent+dye ink (reducing-retardant dye) [one-component type].

In embodiments of the dye discharging ink for inkjet printing of the present invention, an especially preferable mixing ratio in the form (A) of the “discharging liquid containing a discharging agent” of the two-component type is a discharging liquid composition containing 6-10 weight % Rongalite as the sulphur reducing agent and 3-7 weight % triethanolamine, for example. The hydrogen ion concentration of the discharging liquid is preferably in a range of from a pH of 9.5 to a pH of 11.0.

The above discharging liquid composition is for illustrative purposes only. The amount of the amine compound can be increased or decreased according to an increase or decrease in the amount of Rongalite. The present invention is not limited to the above composition.

### EXAMPLES

By way of illustration, exemplary embodiments of the present invention will be described below.

The following comparison tests (I) and (II) were conducted as to embodiments of a dye discharging ink for inkjet printing of the invention and a discharging ink as a comparative example: (I) comparison test for effect of preventing damage to inkjet head; and (II) comparison test for effect of maintaining the discharging capability.

The discharging inks used in the comparison tests have composition [A] for exemplary embodiments of the invention, and composition [B] for comparative examples, as follows:

Composition [A]—Composition of the discharging ink as an exemplary embodiment of the present invention:

| | | |
|---|---|---|
| Rongalite | 6 | weight % |
| Triethanolamine | 5 | weight % |
| Nonionic surfactant | 6 | weight % |
| Antiseptic agent | 0.05 | weight % |
| Benzotriazole | 0.05 | weight % |
| Diethylene glycol | 15.0 | weight % |
| N-methyl-2-pyrrolidone | 5 | weight % |
| Diethylene glycol monomethyl ether | 5 | weight % |

| | |
|---|---|
| Water | remnant |
| Hydrogen ion concentration of discharging liquid: | pH of 10.5. |

Composition [B]—Composition of the discharging ink as a comparative example:

| | | |
|---|---|---|
| Rongalite | 6 | weight % |
| Sodium bicarbonate | 1 | weight % |
| Sodium nitrilotriacetic acid (NTA) | 1 | weight % |
| Nonionic surfactant | 6 | weight % |
| Antiseptic agent | 0.05 | weight % |
| Benzotriazole | 0.05 | weight % |
| Diethylene glycol | 15.0 | weight % |
| N-methyl-2-pyrrolidone | 5 | weight % |
| Diethylene glycol monomethyl ether | 5 | weight % |

| | |
|---|---|
| Water | remnant |
| Hydrogen ion concentration of discharging liquid: | pH 9.5. |

Test Details for Comparison Test (I)—comparison test for effect of preventing damage to inkjet head:

Respective inkjet heads (each having a wiping mechanism on the head surface) are filled with the discharging inks for inkjet printing of the aforementioned composition [A] and composition [B], respectively. Then, the comparison test (I) was conducted under the conditions set forth below.

For the comparison test (I), an inkjet printer having a discharge printing function (e.g., JV4 available from Mimaki Engineering Co., Ltd.) was used.

(i) A periodical wiping operation for wiping the surface of the nozzle plate every 8 hours was conducted for a month. During this time, the inkjet head remained untouched without printing for a month in a state that the inkjet head is filled with the discharging ink for inkjet printing. After a month, the corrosion (damage) on the surface around the head nozzles was observed by using a microscope. A significant amount of corrosion (damage) was observed in the case of the composition [B], while the corrosion (damage) was significantly prevented in the case of the composition [A] (i.e., exemplary embodiment of the present invention).

(ii) A test printing using an inkjet printer (e.g., JV4 available from Mimaki Engineering Co., Ltd.) in which the discharging ink for inkjet printing was ejected from nozzles to print a nozzle check pattern was conducted periodically (e.g., every day). Deflection occurred after about one week under the continuous operating condition in the case of the composition [B], while anti-damage performance for three weeks under the continuous operating condition was achieved in the case of the composition [A] (i.e., exemplary embodiment of the present invention).

Test Details for Comparison Test (II)—comparison test for effect of maintaining the discharging capability:

The following treatments (1) through (4) were conducted using the discharging inks for inkjet printing of the aforementioned compositions [A] and composition [B], respectively.

For the comparison test (II), an inkjet printer having a discharge printing function (e.g., GP-604D available from Mimaki Engineering Co., Ltd.) was used.

(1) Discharging ink keeping condition: discharging inks that were kept (left) in an environment of 60° C. for zero hour, three weeks, and four weeks were used.

(2) Printing: printing (720 dpi×720 dpi) by the inkjet printer, one-way printing, 2-pass 1-coat, 100% print density.

(3) Discharge printing: after discharge printing on a black colored T-shirt with the discharging liquid under the aforementioned condition (2), the discharged portion was treated by hot press at 160° C. for 60 seconds.

(4) Color-difference measurement: color difference (ΔE) between the non-discharged portion and the discharged portion was measured by a spectrodensitometer (X-Rite 500 series available from X-Rite, Incorporated).

After keeping (leaving) the discharging inks under the aforementioned conditions (1)-(4), the discharge printing was conducted. Resultant color differences (ΔE) were compared between the cases using the composition [A] and composition [B]. The comparison of results are shown in Table 1.

TABLE 1

| | Color Difference | | | |
|---|---|---|---|---|
| | (ΔE) in NBS units | | | |
| | | Ink Left | Ink Left | Rate of |
| | Ink Left | for 3 | for 4 | Change |
| | for 0 days | weeks at | weeks at | (4 weeks/0 |
| | at 60° C. | 60° C. | 60° C. | days) |
| Composition [A] - | 25.00 | 24.82 | 25.27 | 101% |
| Exemplary Embodiment | | | | |
| of Invention | | | | |
| Composition [B] - | 30.5 | 30.3 | 17.3 | 56% |
| Comparative Example | | | | |

The results set forth in Table 1 show that for composition [A] there are little changes in the color difference (ΔE) between the non-discharged portion and the discharge portion from the case where the discharging liquid is left for zero days to the case where the discharging liquid is left for four weeks in the environment of 60° C. In other words, the discharging capability of composition [A] did not deteriorate even after left in the environment of 60° C. for four weeks. This means that the composition [A] according to an embodiment of the present invention can be stored while stably maintaining the discharging capability over a long period of time.

As for composition [B], the discharging capability was decreased by half after left for four weeks.

As is also apparent from the aforementioned examples, the dye discharging ink for inkjet printing according to embodiments of the present invention can prevent head damage due to the sulphur reducing agent and another factor, thereby enabling stable ejection of the discharging ink even when continuously used over a long period of time and keeping its discharging capability over a long period of time.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A dye discharging ink for inkjet printing comprising at least a reducing agent and an amine compound.

2. The dye discharging ink for inkjet printing according to claim 1, wherein said reducing agent is a sulphur reducing agent.

3. The dye discharging ink for inkjet printing according to claim 2, wherein said sulphur reducing agent is Rongalite.

4. The dye discharging ink for inkjet printing according to claim 1, wherein said amine compound is an alcohol amine compound.

5. The dye discharging ink for inkjet printing according to claim 2, wherein said amine compound is an alcohol amine compound.

6. The dye discharging ink for inkjet printing according to claim 3, wherein said amine compound is an alcohol amine compound.

7. The dye discharging ink for inkjet printing according to claim 1, wherein said amine compound is triethanolamine.

8. The dye discharging ink for inkjet printing according to claim 6, wherein said amine compound is triethanolamine.

9. The dye discharging ink for inkjet printing according to claim 1, wherein said dye discharge ink has a pH in a range from 9.5 to 11.0.

10. The dye discharging ink for inkjet printing according to claim 8, wherein said dye discharge ink has a pH in a range from 9.5 to 11.0.

11. The dye discharging ink for inkjet printing according to claim 1, further comprising a surface active surfactant.

12. The dye discharging ink for inkjet printing according to claim 8, further comprising a surface active surfactant.

13. The dye discharging ink for inkjet printing according to claim 11, wherein said surface active surfactant is an acetylene derivative, nonionic surfactant.

14. The dye discharging ink for inkjet printing according to claim 12, wherein said surface active surfactant is an acetylene derivative, nonionic surfactant.

15. The dye discharging ink for inkjet printing according to claim 1, further comprising an antirust agent.

16. The dye discharging ink for inkjet printing according to claim 8, further comprising an antirust agent.

17. The dye discharging ink for inkjet printing according to claim 12, further comprising an antirust agent.

18. A dye discharging ink for inkjet printing, said dye discharging ink comprising:
a discharging liquid;
a reducing agent provided within said discharge liquid; and
an amine compound provided within said discharge liquid in coexistence with said reducing agent.

19. The dye discharging ink for inkjet printing according to claim 18, wherein said reducing agent is a sulphur reducing agent, and wherein said amine compound is an alcohol amine compound.

20. The dye discharging ink for inkjet printing according to claim 19, further comprising:
a surface active surfactant provided in said discharge liquid; and
an antirust agent provided in said discharge liquid,
wherein said sulphur reducing agent is Rongalite,
wherein said alcohol amine compound is triethanolamine, and
wherein said dye discharge ink has a pH in a range from 9.5 to 11.0.
